(19) United States
(12) Patent Application Publication
(10) Pub. No.: US 2020/0310751 A1
(43) Pub. Date: Oct. 1, 2020

(54) SYSTEM AND METHOD OF MANAGING DEVICE SOUND LEVEL

(71) Applicant: QUALCOMM Incorporated, San Diego, CA (US)

(72) Inventors: Shankar ANAND, Hyderabad (IN); Ashokkumar NARAYANASWAMY, Hyderabad (IN); Amandeep Singh BEDI, Nawanshahr (IN)

(21) Appl. No.: 16/370,838

(22) Filed: Mar. 29, 2019

(51) Int. Cl. G06F 3/16; H04R 1/22; G06F 9/30; G10L 15/05

(52) U.S. Cl. CPC G06F 3/167; G10L 15/05; G06F 9/3004; H04R 1/222

(57) ABSTRACT

A device includes a memory and a processor. The memory is configured to store a first threshold. The processor is configured to determine an audio interference metric based on detecting a keyword in a first audio input. The processor is also configured to perform a comparison of the audio interference metric to the first threshold. The processor is further configured to initiate, based on the comparison, transmission of a first instruction to a second device to cause the second device to reduce an output sound level.

### I. FIELD

The present disclosure is generally related to device sound level management.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

A computing device may support voice-activated functionality. For example, a user says a keyword and the computing device detects the keyword in audio input received via a microphone. The user says a command after saying the keyword. The computing device performs one or more actions based on detecting the keyword and the command. In some situations, there is a high level of ambient noise from other sources, e.g., audio from a television, noise from a dishwasher during a wash cycle, noise from a dryer during a drying cycle, or a combination thereof. The high level of ambient noise increases errors in detecting the command. For example, the computing device may have trouble recognizing a valid command or may erroneously detect a command based on the audio from the television instead of the user speech. Having to take user actions (e.g., turning down the volume of the television, pausing the wash cycle of the dishwasher, pausing the drying cycle of the drying, moving closer to the microphone, or speaking louder) to reduce the error adversely impacts the user experience.

### III. SUMMARY

In a particular aspect, a device includes a memory and a processor. The memory is configured to store a first threshold. The processor is configured to determine an audio interference metric based on detecting a keyword in a first audio input. The processor is also configured to perform a comparison of the audio interference metric to the first threshold. The processor is further configured to initiate, based on the comparison, transmission of a first instruction to a second device to cause the second device to reduce an output sound level.

In another particular aspect, a method of managing device sound level includes receiving, at a first device, a first audio input. The method also includes determining an audio interference metric based on detecting a keyword in the first audio input. The method further includes performing a comparison of the audio interference metric to a first threshold. The method also includes, based on the comparison, sending a first instruction from the first device to a second device to cause the second device to reduce an output sound level.

In another particular aspect, a computer-readable storage device stores instructions that, when executed by one or more processors, cause the one or more processors to determine an audio interference metric based on detecting a keyword in a first audio input. The audio interference metric indicates a first level of ambient noise detected in the first audio input. The instructions, when executed by the one or more processors, also cause the one or more processors to, based on the determining that the first level of ambient noise is greater than a threshold level of ambient noise, initiate transmission of a first instruction from a first device to a second device to cause the second device to reduce an output sound level.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of a particular illustrative example of a system operable to manage device sound level;

FIG. 2 is a diagram of another particular illustrative example of a system operable to manage device sound level;

FIG. 3 is a flow chart illustrating a particular method of managing device sound level;

FIG. 4 is a flow chart illustrating another particular method of managing device sound level;

FIG. 5 is a flow chart illustrating another particular method of managing device sound level; and

FIG. 6 is a block diagram of a particular illustrative example of a device that is operable to manage device sound level.

### V. DETAILED DESCRIPTION

Systems and methods operable to manage device sound level are disclosed. A first device includes an audio manager. The audio manager is configured to, in response to detecting a keyword in a first audio input, send an instruction to a second device to reduce an output sound level. In some examples, the audio manager determines an audio interference metric based on the first audio input. The audio interference metric indicates a level of ambient noise. The audio manager selectively sends the instruction based on a comparison of the audio interference metric to a threshold. To illustrate, the audio manager sends the instruction if the audio interference metric indicates a higher than threshold level of ambient noise. In some examples, the audio manager sends a status request to the second device, receives status information from the second device, and selectively sends the instruction to the second device in response to determining that the status information corresponds to a higher than threshold level of output sound level. In some examples, the audio manager sends the instruction to multiple second devices. The audio manager, subsequent to sending the instruction, detects a command in a second audio input and performs one or more actions corresponding to the command. Sending the instruction to the second device causes the second device to reduce an output sound level. The lower ambient noise level reduces a likelihood of errors in detecting the command in the second audio input and improves the user experience.

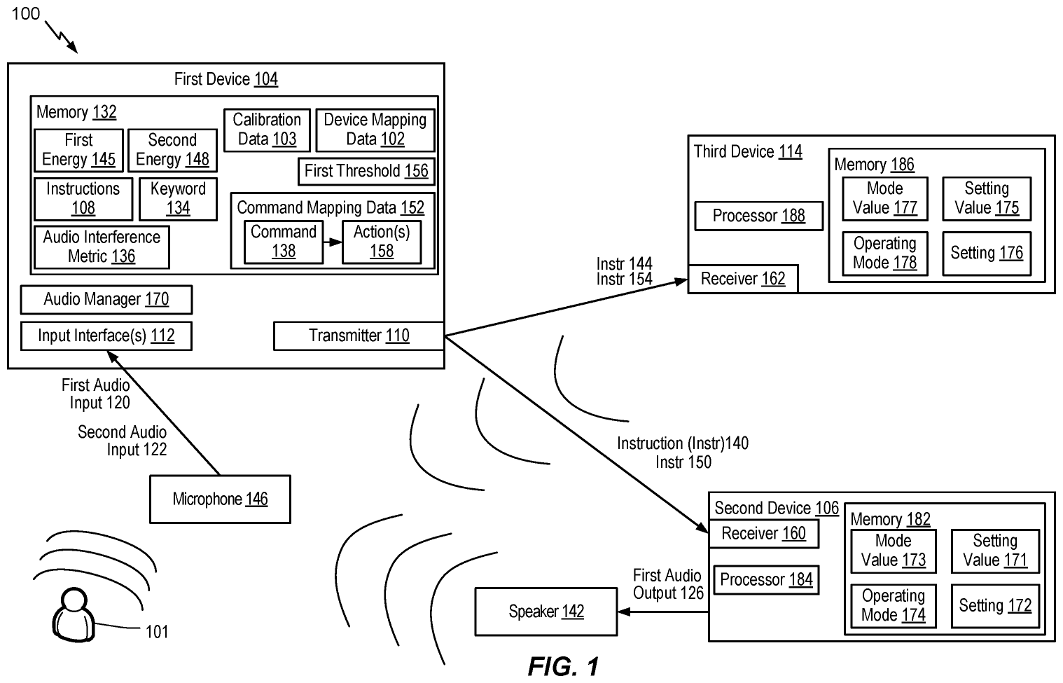

Referring to FIG. 1, a particular illustrative aspect of a system operable to manage device sound level is disclosed and generally designated 100. The system 100 includes a plurality of devices, such as a first device 104, a second device 106, a third device 114, or a combination thereof. The first device 104 is within a communication range of the second device 106, the third device 114, or both. In a particular aspect, the first device 104 can enter or exit a communication range of the second device 106, a communication range of the third device 114, or both, at various times. In a particular aspect, the second device 106, the third device 114, or both, can enter or exit a communication range of the first device 104 at various times. It should be understood that the system 100 including three devices is provided as an illustrative examples. In other examples, the system 100 includes fewer than three devices or more than three devices.

It should be noted that in the following description, various functions performed by the system 100 of FIG. 1 are described as being performed by certain components or modules. However, this division of components and modules is for illustration only. In an alternate aspect, a function performed by a particular component or module may be divided amongst multiple components or modules. Moreover, in an alternate aspect, two or more components or modules of FIG. 1 may be integrated into a single component or module. Each component or module illustrated in FIG. 1 may be implemented using hardware (e.g., a field-programmable gate array (FPGA) device, an application-specific integrated circuit (ASIC), a digital signal processor (DSP), a controller, etc.), software (e.g., instructions executable by a processor), or any combination thereof.

The first device 104 includes a memory 132, an audio manager 170, one or more input interfaces 112, a transmitter 110, or a combination thereof. The transmitter 110 is configured to transmit instructions to various devices. The memory 132 is configured to store one or more instructions 108 that, when executed by a processor, cause the processor to perform one or more operations described herein. The memory 132 is also configured to store command mapping data 152 indicating one or more commands and corresponding actions. For example, the command mapping data 152 indicates that one or more actions 158 correspond to a command 138. The input interfaces 112 are coupled to one or more microphones, such as a microphone 146.

In a particular aspect, the memory 132 is configured to store calibration data 103. For example, during a calibration phase, the audio manager 170, in response to detecting the second device 106 within a communication range of the first device 104, performs a calibration of an output sound level of the second device 106. To illustrate, the audio manager 170 sends an output sound calibration request to the second device 106. The second device 106, in response to receiving the output sound calibration request, sends a first setting value, a first mode value, or both, to the first device 104 and performs operations based on the first setting value, the first mode value, or both. In a particular example, the second device 106 includes a media player. In this example, the second device 106 performs the operations by outputting a first audio signal based on the first setting value (e.g., a first audio volume). In another example, the second device 106 includes a dishwasher. In this example, the second device 106 performs the operations by initiating a first dishwasher cycle (e.g., a speed cycle) corresponding to the first mode value (e.g., a first speed mode).

The audio manager 170 receives a first audio input from the microphone 146 subsequent to receiving the first setting value, the first mode value, or both, from the second device 106. The first audio input corresponds to a first output sound level generated at least in part by the second device 106 performing the operations corresponding to the first setting value (e.g., a first audio volume), the first mode value (e.g., a low speed mode), or both. The audio manager 170 generates a first audio metric (e.g., a first decibel measurement) based on the first audio input. The audio manager 170 generates (or updates) the calibration data 103 to indicate that, for the second device 106, the first setting value, the first mode value, or both, correspond to the first audio metric (e.g., the first decibel measurement).

The second device 106, subsequent to performing operations based on the first setting value, the first mode value, or both, sends a second setting value (e.g., a second audio volume), a second mode value (e.g., a OFF mode), or both, to the first device 104 and performs operations based on the second setting value, the second mode value, or both. The audio manager 170 receives a second audio input from the microphone 146 subsequent to receiving the second setting value, the second mode value, or both, from the second device 106. The second audio input corresponds to a second output sound level generated at least in part by the second device 106 performing the operations corresponding to the second setting value, the second mode value, or both. The audio manager 170 generates a second audio metric (e.g., a second decibel measurement) based on the second audio input. The audio manager 170 generates (or updates) the calibration data 103 to indicate that, for the second device 106, the second setting value, the second mode value, or both, correspond to the second audio metric (e.g., the second decibel measurement).

The audio manager 170 is configured to receive first audio input 120 from the microphone 146. The audio manager 170 is configured to, in response to detecting a keyword 134 in the first audio input 120, generate an audio interference metric 136 based on the first audio input 120. The audio manager 170 is configured to compare the audio interference metric 136 to a first threshold 156. In a particular aspect, the first threshold 156 corresponds to a default value, a configuration setting, user input, or a combination thereof. The audio manager 170 is configured to, based on the comparison of the audio interference metric 136 to the first threshold 156, send an instruction via the transmitter 110 to one or more devices to reduce an output sound level. For example, the audio manager 170 is configured to, based on the comparison of the audio interference metric 136 to the first threshold 156, send an instruction 140 to the second device 106 to reduce an output sound level. To illustrate, the audio manager 170 is configured to send the instruction 140 to the second device 106 to cause the second device 106 to change to a setting, an operating mode, or both, corresponding to a lower output sound level. As another example, the audio manager 170 is configured to, based on the comparison of the audio interference metric 136 to the first threshold 156, send an instruction 144 to the second device 106 to reduce an output sound level.

The second device 106 includes a receiver 160, a memory 182, a processor 184, or a combination thereof. The receiver 160 is configured to receive the instruction 140. The memory 182 is configured to store a setting 172, an operating mode 174, or both. In a particular example, the setting 172 corresponds to an output volume setting. In a particular example, the operating mode 174 of the second device 106 corresponds to particular operations that the second device 106 is performing, is about to perform, or a combination thereof. Performing the particular operations generates a particular level (e.g., none, low, medium, or high) of output sound. In a particular example, the second device 106 corresponds to a dishwasher and the operating mode 174 indicates whether the dishwasher is in a quiet mode (e.g., a less noisy and longer cycle) or a speed mode (e.g., a louder and shorter cycle). The processor 184 is configured to, in response to receiving the instruction 140, update the setting 172, the operating mode 174, or both, to reduce an output sound level. In FIG. 1, the second device 106 is coupled to a speaker 142. The second device 106 (e.g., a media player) is configured to generate a first audio output 126 based at least in part on the setting 172 (e.g., a volume setting), the operating mode 174 (e.g., a play mode), or both.

The third device 114 includes a receiver 162, a memory 186, a processor 188, or a combination thereof. The memory 182 is configured to store a setting 176, an operating mode 178, or both. The processor 188 is configured to, in response to receiving the instruction 140, update the setting 176, the operating mode 178, or both, to reduce an output sound level. In FIG. 1, the third device 114 (e.g., a dishwasher) generates sound based at least in part on the setting 176, the operating mode 178 (e.g., a wash mode), or both.

The audio manager 170 is configured to, subsequent to sending the instruction 140, the instruction 144, or both, receive a second audio input 122 from the microphone 146. The audio manager 170 is configured to perform the actions 158 in response to detecting the command 138 in the second audio input 122. In a particular aspect, the audio manager 170 is configured to, subsequent to detecting an event, cause the one or more device to revert the output sound level. For example, the event includes receipt of the second audio input 122, detecting the command 138, performing the actions 158, or a combination thereof. For example, the audio manager 170 is configured to, subsequent to receipt of the second audio input 122, detecting the command 138, performing the actions 158, or a combination thereof, send an instruction 150 to the second device 106 to revert the output sound level. The processor 184 is configured to, in response to the receiver 160 receiving the instruction 150, revert the setting 172, the operating mode 174, or both. As another example, the audio manager 170 is configured to, subsequent to receipt of the second audio input 122, detecting the command 138, performing the actions 158, or a combination thereof, send an instruction 154 to the third device 114 to revert the output sound level. The processor 184 is configured to, in response to the receiver 162 receiving the instruction 154, revert the setting 176, the operating mode 178, or both.

During operation, a user 101 says the keyword 134 within range of the microphone 146. The input interfaces 112 receive the first audio input 120 from the microphone 146. The first audio input 120 corresponds to the speech of the user and ambient noise, if any, picked up by the microphone 146. For example, the first audio input 120 corresponds to the keyword 134 spoken by the user 101, sound generated by the second device 106 (e.g., by the speaker 142), sound generated by the third device 114, or a combination thereof.

The audio manager 170 performs speech recognition to determine whether the first audio input 120 includes the keyword 134. The audio manager 170, in response to detecting the keyword 134 in the first audio input 120, generates the audio interference metric 136 based on the first audio input 120. The audio interference metric 136 indicates a first level of ambient noise detected in the first audio input 120. For example, the audio manager 170 identifies a portion of the first audio input 120 corresponding to the keyword 134. The audio manager 170 determines a first energy 145 associated with the identified portion of the first audio input 120. The audio manager 170 determines a second energy 148 associated with a second portion of the first audio input 120. In a particular aspect, the identified portion is smaller than the second portion. In a particular aspect, the second portion includes the identified portion and one or more additional portions of the first audio input 120. In a particular aspect, the second portion at least partially overlaps the identified portion. In a particular aspect, the second portion is distinct from the identified portion. The audio manager 170 determines the audio interference metric 136 based on the first energy 145 and the second energy 148. In a particular example, the audio interference metric 136 is based on a comparison of the first energy 145 and the second energy 148. To illustrate, the audio interference metric 136 indicates a difference in sound intensity of the portion of the first audio input 120 corresponding to the keyword 134 and sound intensity of the first audio input 120 overall.

The audio manager 170 compares the audio interference metric 136 to the first threshold 156. The first threshold 156 indicates a threshold level of ambient noise. In a particular example, the first threshold 156 indicates a minimum difference between the first energy 145 and the second energy 148 that corresponds to a tolerable level of speech recognition errors (e.g., no errors) in detecting commands (e.g., the commands indicated by the command mapping data 152). The audio manager 170, based on the comparison, sends an instruction to one or more devices to reduce an output sound level. For example, the audio manager 170, based on determining that the first level of ambient noise (indicated by the audio interference metric 136) is greater than the threshold level of ambient noise (indicated by the first threshold 156), sends an instruction to one or more devices to reduce an output sound level. In a particular example, the audio manager 170 detects that the second device 106, the third device 114, or both, are within a communication range of the first device 104. The audio manager 170, in response to determining that the audio interference metric 136 fails to satisfy (e.g., is less than) the first threshold 156, transmits, via the transmitter 110, the instruction 140 to the second device 106, the instruction 144 to the third device 114, or both.

The processor 184, in response to receiving the instruction 140 via the receiver 160, updates the setting 172, the operating mode 174, or both. In a particular implementation, the processor 184 updates the setting 172 to a predetermined setting (e.g., a mute setting), the operating mode 174 to a predetermined operating mode (e.g., a pause mode), or both. In a particular implementation, the processor 184 stores a setting value 171 (e.g., a current setting value) of the setting 172 in the memory 182 prior to updating the setting 172, stores a mode value 173 (e.g., a current mode value) of the operating mode 174 (e.g., a first operating mode) prior to updating the operating mode 174 (e.g., to a second operating mode) in the memory 182, or both. The processor 184 can later use the stored values (e.g., the setting value 171, the mode value 173, or both) to restore the setting 172, the operating mode 174, or both, as described herein.

In a particular implementation, the first device 104 maintains device mapping data 102 that indicates setting values, mode values, or a combination thereof, that correspond to low output sound levels for various devices. To illustrate, the device mapping data 102 indicates that, for the second device 106, a setting value (e.g., a mute setting), a mode value (e.g., a pause mode), or both, correspond to a low output sound level. The audio manager 170 generates the instruction 140 indicating the setting value, the mode value, or both.

In a particular implementation, the audio manager 170 generates the device mapping data 102 based on the calibration data 103. For example, the audio manager 170 selects, for the second device 106, one or more mode values, one or more setting values, or a combination thereof, for which respective audio metrics (e.g., decibel measurements) are lower than a particular output sound threshold. To illustrate, the audio manager 170, in response to determining that a particular mode value (e.g., a low speed mode) of the second device 106 corresponds to a particular audio metric (e.g., a particular decibel measurement) and that the particular audio metric satisfies (e.g., is less than or equal to) the particular output sound threshold, updates the device mapping data 102 to indicate that the particular mode value (e.g., the low speed mode) of the second device 106 corresponds to a low output sound level.

In a particular implementation, the audio manager 170 is configured to indicate different mode values, different setting values, or both, in an instruction for a particular device based on a level of ambient noise detected in the first audio input 120. For example, the memory 132 includes the first threshold 156, a second threshold, one or more additional thresholds, or a combination thereof. The first threshold 156 corresponds to higher ambient noise than the second threshold. For example, the audio interference metric 136 being less than the second threshold indicates that low ambient noise is detected in the first audio input 120. The audio interference metric 136 being greater than the second threshold and less than the first threshold 156 indicates that medium ambient noise is detected in the first audio input 120. The audio interference metric 136 being greater than the first threshold 156 indicates that high ambient noise is detected in the first audio input 120. In this implementation, the device mapping data 102 indicates that a setting, operating mode, or both, of a particular device is to be updated to correspond to a lower output sound level when higher ambient noise is detected. For example, the memory 132 stores a first target output sound level corresponding to the first threshold 156, a second target output sound level corresponding to the second threshold, one or more additional target output sound levels corresponding to one or more additional thresholds, or a combination thereof. In a particular aspect, the first target output sound level is lower than the second target output sound level. The audio manager 170 determines that the calibration data 103 indicates that a first setting value (e.g., a first volume setting), a first mode value (e.g., a low speed mode), or both, of the second device 106 correspond to a first audio metric. The audio manager 170, in response to determining that the first audio metric is greater than the first target output sound level and less than the second target output sound level, updates the device mapping data 102 to indicate that the second threshold corresponds to the first setting value (e.g., the first volume setting), the first mode value (e.g., the low speed mode), or both, of the second device 106.

The audio manager 170 determines that the calibration data 103 indicates that a second setting value (e.g., a MUTE volume setting), a second mode value (e.g., an OFF mode), or both, of the second device 106 correspond to a second audio metric. The audio manager 170, in response to determining that the second audio metric is less than the first target output sound level, updates the device mapping data 102 to indicate that the first threshold 156 corresponds to the second setting value (e.g., a MUTE volume setting), the second mode value (e.g., an OFF mode), or both, of the second device 106.

In a particular example, the audio manager 170 determines that the audio interference metric 136 is greater than the first threshold 156 and that the device mapping data 102 indicates that, for the second device 106, the second setting value (e.g., a MUTE volume setting), the second mode value (e.g., an OFF mode), or both, correspond to the first threshold 156. In this example, the audio manager 170, in response to the determination, generates the instruction 140 indicating the second setting value (e.g., a MUTE volume setting), the second mode value (e.g., an OFF mode), or both. In another example, the audio manager 170 determines that the audio interference metric 136 is less than or equal to the first threshold 156 and greater than the second threshold and that the device mapping data 102 indicates that, for the second device 106, the first setting value (e.g., the first volume setting), the first mode value (e.g., a low speed mode), or both, correspond to the second threshold, generates the instruction 140 indicating the first setting value, the first mode value, or both.

In a particular example, the processor 184, in response to determining that the instruction 140 indicates a setting value, updates the setting 172 based on the setting value. To illustrate, the processor 184 sets the setting 172 to the setting value (e.g., a mute setting). In another example, the processor 184, in response to determining that the instruction 140 indicates a mode value, updates the operating mode 174 based on the mode value. To illustrate, the processor 184 sets the operating mode 174 to the mode value. The audio manager 170 thus causes the second device 106 to reduce the output sound level by a greater amount when higher ambient noise is detected.

The processor 188, in response to receiving the instruction 144, updates the setting 176 based on a particular setting value, updates the operating mode 178 based on a particular operating mode value, or both. The particular setting value includes a predetermined value, a value indicated by the instruction 144, or both. The particular operating mode value includes a predetermined value, a value indicated by the instruction 144, or both. In a particular implementation, the processor 188 stores a setting value 175 (e.g., a current setting value) of the setting 176 in the memory 186 prior to updating the setting 176, stores a mode value 177 (e.g., a current mode value) of the operating mode 178 prior to updating the operating mode 178 in the memory 186, or both. The processor 188 can later use the stored values (e.g., the setting value 175, the mode value 177, or both) to restore the setting 172, the operating mode 174, or both, as described herein.

In a particular aspect, the audio manager 170 sends the instruction 140 to cause the second device 106 to update the setting 172 and sends the instruction 144 to cause the third device 114 to update the operating mode 178. For example, the second device 106 includes a media player that updates a volume setting and the third device 114 includes a dishwasher that transitions to a pause mode.

In a particular aspect, the audio manager 170 sends the instruction 140 to cause the second device 106 to update the setting 172 to a first setting value and sends the instruction 144 to cause the third device 114 to update the setting 176 to a second setting value. For example, the instruction 140 indicates the first setting value and the instruction 144 indicates the second setting value. In a particular example, the second device 106 includes a first television that sets the output volume to the first setting value and the third device 114 includes a second television that sets the output volume to the second setting value.

In a particular aspect, the audio manager 170 sends the instruction 140 to cause the second device 106 to update the operating mode 174 to a first mode value and sends the instruction 144 to cause the third device 114 to update the operating mode 178 to a second mode value. For example, the instruction 140 indicates the first mode value and the instruction 144 indicates the second mode value.

In a particular aspect, the audio manager 170 sends the instruction 140 to cause the second device 106 to update both the setting 172 and the operating mode 174 and sends the instruction 144 to cause the third device 114 to update one of the setting 176 or the operating mode 178. In a particular aspect, the audio manager 170 sends instructions to cause more than two devices to update settings, operating modes, or a combination thereof. In a particular aspect, the audio manager 170 sends an instruction to cause a single device to update a setting, an operating mode, or both.

In a particular example, the second device 106 includes a media player and updates (e.g., reduces) a volume of the first audio output 126 based on the setting 172 (e.g., a mute setting or a reduction by half setting) to reduce an output sound level. In a particular example, the third device 114 includes a dishwasher and reduces an output sound level by performing (or refraining from performing) operations based on the operating mode 178 (e.g., an OFF mode or a quiet mode).

The user 101 speaks the command 138 subsequent to speaking the keyword 134. In a particular example, the second device 106 reduces an output sound level (e.g., by updating the first audio output 126) prior to the user 101 speaking the command 138. In a particular example, the third device 114 reduces an output sound level (e.g., based on the update to the operating mode 178) prior to the user 101 speaking the command 138. The input interfaces 112 receive the second audio input 122. For example, the input interfaces 112 receive the second audio input 122 subsequent to the transmitter transmitting the instruction 140 to the second device 106, the instruction 144 to the third device 114, or both.

The audio manager 170, in response to detecting the keyword 134 in the first audio input 120, performs speech recognition to determine whether the second audio input 122 includes any commands. The audio manager 170 detects the command 138 in the second audio input 122. Because the user 101 says the command 138 subsequent to the second device 106 reducing an output sound level, the third device 114 reducing an output sound level, or both, an error associated with speech recognition of the command 138 is reduced (e.g., no error). The audio manager 170 determines that the command mapping data 152 indicates that the command 138 (e.g., “weather”) maps to the actions 158 (e.g., retrieve weather information from a database and output an audio signal based on the weather information). The audio manager 170 performs the actions 158.

In a particular implementation, the audio manager 170, subsequent to detecting an event, sends the instruction 150 to the second device 106, the instruction 154 to the third device 114, or both. For example, the event includes receipt of the second audio input 122, detection of the command 138, performance of the actions 158, or a combination thereof. The processor 184 reverts the setting 172, the operating mode 174, or both, in response to receiving the instruction 150. For example, the processor 184, in response to receiving the instruction 150, updates the setting 172 based on the setting value 171, updates the operating mode 174 based on the mode value 173, or both. The processor 188 reverts the setting 176, the operating mode 178, or both, in response to receiving the instruction 154. For example, the processor 188, in response to receiving the instruction 154, updates the setting 176 based on the setting value 175, updates the operating mode 178 based on the mode value 177, or both.

The system 100 thus improves user experience by reducing an error associated with detecting the command 138 in the second audio input 122. For example, the second device 106, in response to receiving the instruction 140, reduces an output sound level prior to the user 101 speaking the command 138. With lower ambient noise, a likelihood of errors in detecting the command 138 is reduced.

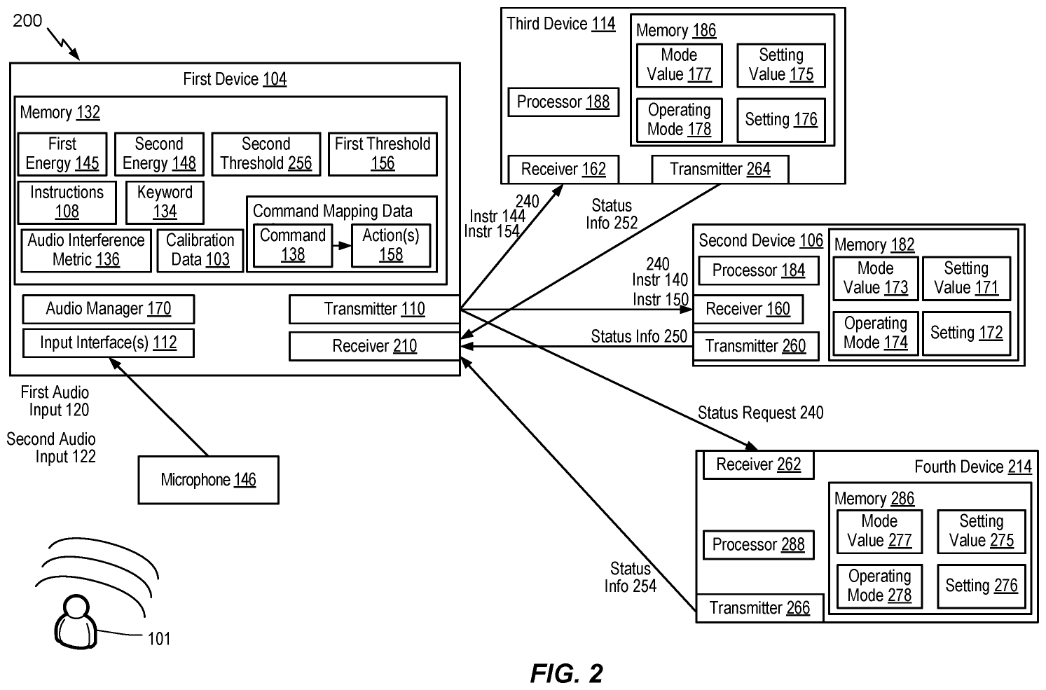

Referring to FIG. 2, an illustrative example of a system operable to manage device sound level is shown and generally designated 200. The system 200 includes a fourth device 214. The fourth device 214 includes a receiver 262, a processor 288, a transmitter 266, a memory 286, or a combination thereof. The first device 104 includes a receiver 210. The second device 106 includes a transmitter 260. The third device 114 includes a transmitter 264.

FIG. 2 differs from FIG. 1 in that the audio manager 170 sends a status request 240 to one or more devices, receives status information from a subset of the one or more devices, and sends an instruction to a device to reduce an output sound level based on the status information received from the device, as described herein. For example, the audio manager 170, in response to detecting the keyword 134 in the first audio input 120, determines the audio interference metric 136 based on the first audio input 120, as described with reference to FIG. 1. The audio manager 170, in response to determining that the audio interference metric 136 fails to satisfy (e.g., is greater than) the first threshold 156, transmits the status request 240 via the transmitter 110. Devices (or receivers) within a communication range of the first device 104 (e.g., the transmitter 110) receives the status request 240. For example, one or more of the receiver 160, the receiver 162, or the receiver 262 receive the status request 240. The processor 188, in response to receiving the status request 240 from the first device 104, transmits status information 252 via the transmitter 264 to the first device 104. The status information 252 indicates the setting value 175 (e.g., a current setting value) of the setting 176, the mode value 177 (e.g., a current mode value) of the operating mode 178, or both.

Similarly, the processor 184, in response to receiving the status request 240 from the first device 104, transmits status information 250 via the transmitter 260 to the first device 104. The status information 250 indicates the setting value 171, the mode value 173, or both. The processor 288, in response to receiving the status request 240 from the first device 104, transmits status information 254 via the transmitter 266 to the first device 104. The status information 254 indicates a setting value 275 (e.g., a current setting value) of a setting 276, a mode value 277 (e.g., a current mode value) of an operating mode 278, or both.

The audio manager 170 receives, via the receiver 210 from a set of devices, status information responsive to the status request 240. For example, the audio manager 170 receives the status information 250, the status information 252, and the status information 254 from the second device 106, the third device 114, and the fourth device 214, respectively. The audio manager 170 based on the status information selects a first subset of devices from the set of devices. For example, the audio manager 170 selects the second device 106 in response to determining that the status information 250 fails to satisfy the second threshold 256. In a particular example, the audio manager 170 determines that the status information 250 fails to satisfy the second threshold 256 in response to determining that the setting value 171 (e.g., an audio volume) is greater than a setting value threshold (e.g., an audio volume threshold) indicated by the second threshold 256. In a particular example, the audio manager 170 determines that the status information 250 fails to satisfy the second threshold 256 in response to determining that the mode value 177 (e.g., a speed mode) does not match any mode values (e.g., an OFF mode or a quiet mode) indicated by the second threshold 256.

The audio manager 170 selects the third device 114 in response to determining that the status information 252 fails to satisfy the second threshold 256. The audio manager 170 refrains from selecting the fourth device 214 in response to determining that the status information 254 satisfies the second threshold 256. In a particular example, the audio manager 170 determines that the status information 254 satisfies the second threshold 256 in response to determining that the setting value 275 is less than or equal to a setting value threshold indicated by the second threshold 256. In a particular example, the audio manager 170 determines that the status information 254 satisfies the second threshold 256 in response to determining that the mode value 277 matches at least one mode value (e.g., an OFF mode or a quiet mode) indicated by the second threshold 256.

The audio manager 170 sends an instruction to each of the selected devices to reduce an output sound level. For example, the transmission of the instruction 140 is initiated in response to the comparison indicating that the status information 250 fails to satisfy the second threshold 256. The audio manager 170, in response to determining that the status information 254 satisfies the second threshold 256, refrains from sending an instruction to the fourth device 214 to cause the fourth device 214 to reduce an output sound level.

In a particular implementation, the second threshold 256 is device-specific. Whereas the device mapping data 102 indicates what setting, operating mode, or both, a device should be instructed to have when a particular level of ambient noise (e.g., medium ambient noise or high ambient noise) is detected, the second threshold 256 indicates when the device should be instructed to update the setting, operating mode, or both. For example, a device that is not contributing to the output sound level does not have to be instructed to update a setting, an operating mode, or both. To illustrate, the second threshold 256 indicates a first setting value threshold, a first set of mode values, or a combination thereof, associated with the second device 106. The audio manager 170 sends the instruction 140 to the second device 106 based on a comparison of the status information 250 to the first setting value threshold, the first set of mode values, or a combination thereof. For example, the audio manager 170 sends the instruction 140 to the second device 106 in response to determining that the setting value 171 is greater than the first setting value threshold, that the first set of mode values (e.g., a pause mode and an OFF mode) do not include the mode value 173, or both. In a particular example, the second threshold 256 indicates a second setting value threshold, a second set of mode values, or a combination thereof, associated with the fourth device 214. The audio manager 170 refrains from sending an instruction to the fourth device 214 based on a comparison of the status information 254 to the second setting value threshold, the second set of mode values, or a combination thereof. For example, the audio manager 170 refrains from sending an instruction to the fourth device 214 in response to determining that the setting value 275 is less than or equal to the second setting value threshold, that the second set of mode values (e.g., a pause mode and an OFF mode) include the mode value 277, or both.

The second threshold 256 (e.g., the first setting value threshold, the first set of mode values, the second setting value threshold, the second set of mode values, or a combination thereof) is based on configuration data, default values, user input, the calibration data 103, data received from other devices, or a combination thereof. For example, the calibration data 103 indicates that, for the second device 106, a first setting value (e.g., a first volume setting), a first mode value (e.g., a low speed mode), or both, correspond to a first audio metric, as described with reference to FIG. 1. The calibration data 103 indicates that, for the second device 106, a second setting value (e.g., a MUTE volume setting), a second mode value (e.g., an OFF mode), or both correspond to a second audio metric, as described with reference to FIG. 1. The memory 132 includes an output sound level threshold. A particular device having a setting value or a mode value that corresponds to an audio metric that is greater than the output sound level threshold is to be sent an instruction to reduce an output sound level. Alternatively, a particular device having a setting value or a mode value that corresponds to an audio metric that is less than or equal to the output sound level threshold is not to be sent an instruction to reduce an output sound level. To illustrate, the audio manager 170, in response to determining that the first audio metric fails to satisfy (e.g., is greater than) the output sound level threshold, refrains from adding the first mode value to the first set of mode values. The audio manager 170, based on a comparison of the second audio metric to the output sound level threshold, selectively updates the second threshold 256 to indicate the second setting value (e.g., a MUTE volume setting) as the first setting value threshold, add the second mode value (e.g., an OFF mode) to the first set of mode values, or both. For example, the audio manager 170, in response to determining that the second audio metric satisfies (e.g., is less than or equal to) the output sound level threshold, updates the second threshold 256 to add the second mode value (e.g., an OFF mode) to the first set of mode values. To illustrate, the audio manager 170 adds the second mode value (e.g., an OFF mode) to the first set of mode values when the second mode value corresponds to a low output sound level that makes a low contribution (e.g., no contribution) to ambient noise.

In a particular example, the audio manager 170, in response to determining that the second audio metric satisfies (e.g., is less than or equal to) the output sound level threshold and that the first audio metric fails to satisfy (e.g., is greater than) the output sound level threshold, updates the second threshold 256 to indicate the second setting value (e.g., the MUTE volume setting) as the first setting value threshold. To illustrate, the audio manager 170 designates the second setting value (e.g., the MUTE volume setting) as the first setting value threshold when the first setting value corresponds to an output sound level that makes a low contribution (e.g., no contribution) to ambient noise and when a next setting value (e.g., the first setting value) corresponds to an output sound level that makes a high (e.g., higher than the output sound level threshold) contribution to ambient noise.

In a particular aspect, the audio manager 170 determines that none of the status information received responsive to the status request 240 fails to satisfy the second threshold 256. In a particular implementation, the audio manager 170, in response to determining that the status information corresponding to each of the devices 106, 114, and 214 satisfies the second threshold 256, sends instructions to reduce an output sound level to all of the devices 106, 114, and 214. In a particular implementation, the audio manager 170, in response to determining that the status information corresponding to each of the devices 106, 114, and 214 satisfies the second threshold 256, refrains from sending instructions to the devices 106, 114, and 214 to reduce an output sound level. In a particular implementation, the audio manager 170, in response to determining that the status information corresponding to each of the devices 106, 114, and 214 satisfies the second threshold 256, selects one or more of the devices 106, 114, and 214 based on corresponding status information and sends instructions to the selected devices to reduce an output sound level.

The system 200 thus enables selectively sending instructions to reduce an output sound level to devices for which status information indicates a setting value, a mode value, or both, corresponding to a higher than threshold output sound level. Settings and operating modes of devices that are likely to have a larger impact on ambient noise are updated.

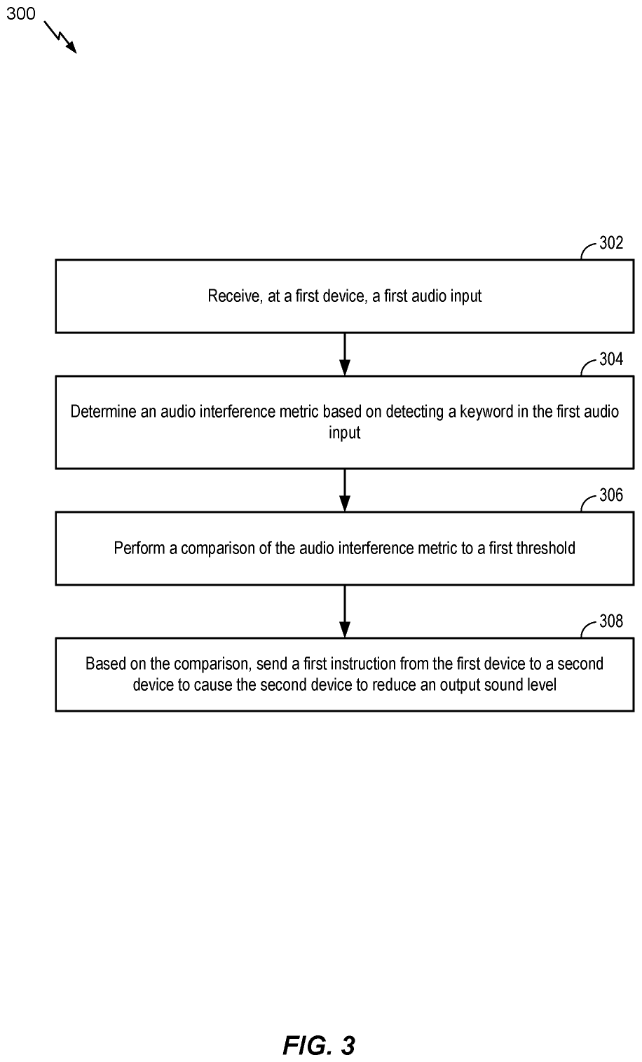

FIG. 3 illustrates a method 300 of managing device sound level. In a particular aspect, the method 300 is performed by the audio manager 170, the first device 104, the system 100 of FIG. 1, the system 200 of FIG. 2, or a combination thereof.

The method 300 includes receiving, at a first device, a first audio input, at 302. For example, the audio manager 170 of FIG. 1 receives the first audio input 120 from the input interfaces 112, as described with reference to FIG. 1.

The method 300 also includes determining an audio interference metric based on detecting a keyword in the first audio input, at 304. For example, the audio manager 170 of FIG. 1 determines the audio interference metric 136 based on detecting the keyword 134 in the first audio input 120, as described with reference to FIG. 1.

The method 300 further includes performing a comparison of the audio interference metric to a first threshold, at 306. For example, the audio manager 170 of FIG. 1 performs a comparison of the audio interference metric 136 to the first threshold 156, as described with reference to FIG. 1.

The method 300 also includes, based on the comparison, sending a first instruction from the first device to a second device to cause the second device to reduce an output sound level, at 308. For example, the audio manager 170 of FIG. 1, based on the comparison, sends the instruction 140 from the first device 104 to the second device 106 to cause the second device 106 to reduce an output sound level, as described with reference to FIG. 1.

The method 300 thus enables selectively sending the instruction 140 to the second device 106 to cause the second device 106 to reduce an output sound level. The reduced output sound level from the second device 106 reduces a likelihood of error in detecting the command 138 in the second audio input 122.

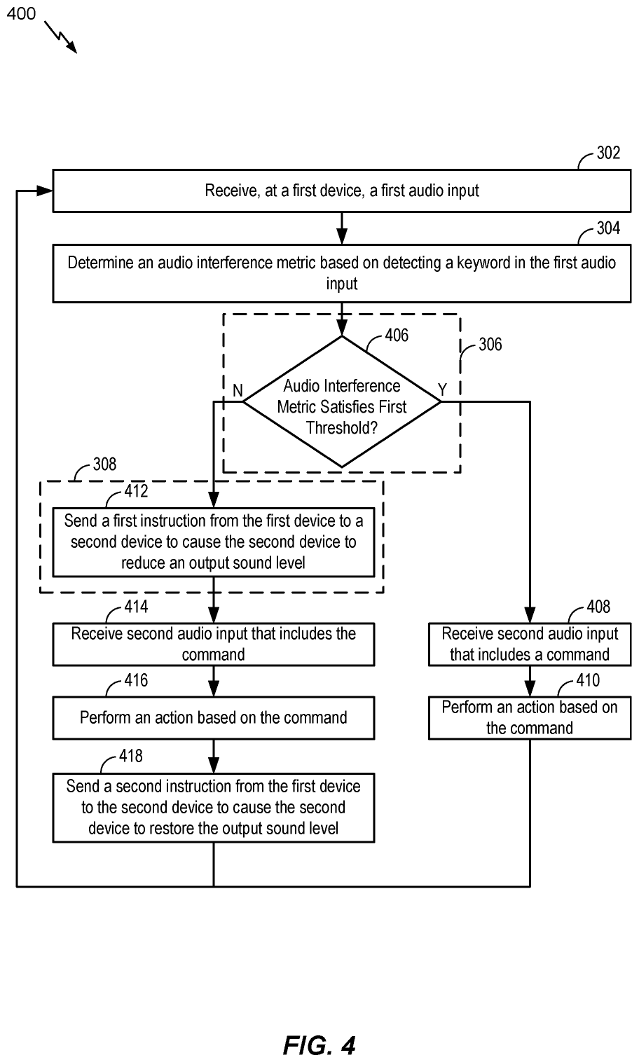

FIG. 4 illustrates a method 400 of managing device sound level. In a particular aspect, the method 400 is performed by the audio manager 170, the first device 104, the system 100 of FIG. 1, the system 200 of FIG. 2, or a combination thereof. The method 400 differs from the method 300 in that the method 400 includes an example implementation of 306 and an example implementation of 308. The method 400 also includes examples of operations that occur subsequent to 306 and examples of operations that occur subsequent to 308.

The method 400 continues from 304 to 406. The method 400 further includes determining whether the audio interference metric satisfies a first threshold, at 406. For example, the audio manager 170 of FIG. 1 determines whether the audio interference metric 136 satisfies the first threshold 156, as described with reference to FIG. 1. In a particular aspect, 406 is an example implementation of 306.

The method 400 includes, in response to determining that the audio interference metric satisfies the first threshold, at 406, receiving second audio input that includes a command, at 408. For example, the audio manager 170 of FIG. 1 receives the second audio input 122 that includes the command 138, as described with reference to FIG. 1.

The method 400 also includes performing an action based on the command, at 410. For example, the audio manager 170 of FIG. 1 performs the actions 158 based on the command 138, as described with reference to FIG. 1. The method 400 returns to 302.

The method 400 includes, in response to determining that the audio interference metric fails to satisfy the first threshold, at 406, sending a first instruction from the first device to a second device to cause the second device to reduce an output sound level, at 412. For example, the audio manager 170 of FIG. 1, in response to determining that the audio interference metric 136 fails to satisfy the first threshold 156, sends the instruction 140 from the first device 104 to the second device 106 to cause the second device 106 to reduce an output sound level, as described with reference to FIG. 1. In a particular aspect, 412 is an example implementation of 308.

The method 400 also includes receiving second audio input that includes the command, at 414. For example, the audio manager 170 of FIG. 1 receives the second audio input 122 that includes the command 138, as described with reference to FIG. 1.

The method 400 further includes performing an action based on the command, at 416. For example, the audio manager 170 of FIG. 1 performs the actions 158 based on the command 138, as described with reference to FIG. 1.

The method 400 also includes sending a second instruction from the first device to the second device to cause the second device to restore the output sound level, at 418. For example, the audio manager 170 of FIG. 1 sends the instruction 150 from the first device 104 to the second device 106 to cause the second device 106 to restore the output sound level, as described with reference to FIG. 1. The method 400 continues to 302.

The method 400 thus enables selectively sending the instruction 140 to the second device 106 to cause the second device 106 to reduce an output sound level. The reduced output sound level from the second device 106 reduces a likelihood of error in detecting the command 138 in the second audio input 122.

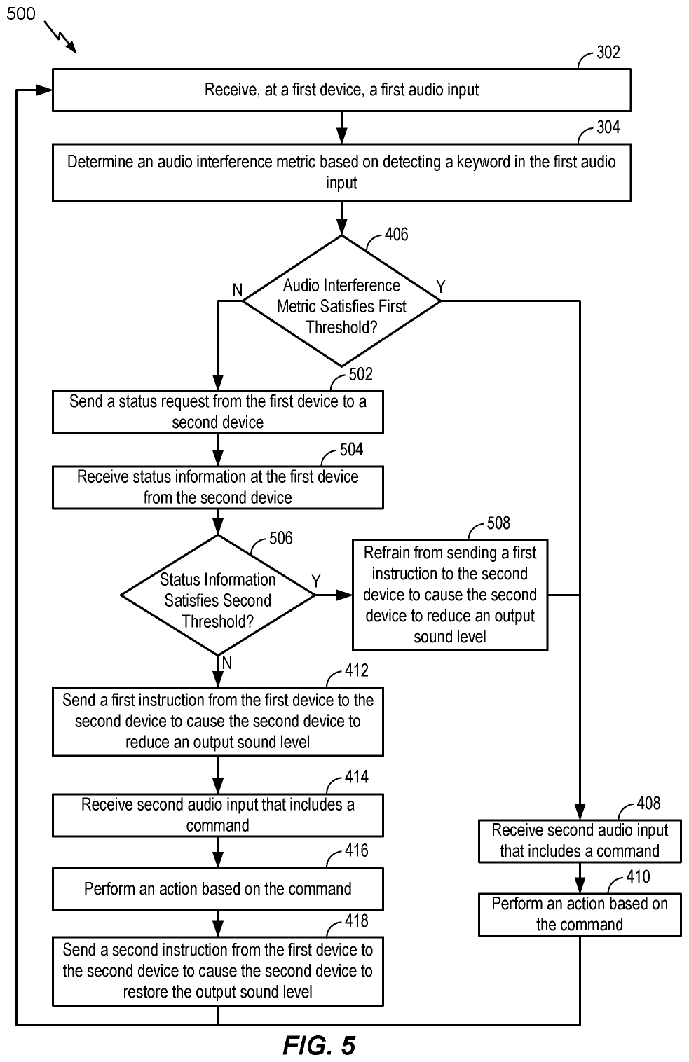

FIG. 5 illustrates a method 500 of managing device sound level. In a particular aspect, the method 500 is performed by the audio manager 170, the first device 104, the system 100 of FIG. 1, the system 200 of FIG. 2, or a combination thereof. The method 500 differs from the method 400 in that the method 500 includes examples of operations that occur subsequent to 406 and prior to 408 and examples of operations that occur subsequent to 406 and prior to 412.

The method 500 includes, in response to determining that the audio interference metric fails to satisfy the first threshold, at 406, sending a status request from the first device to a second device, at 502. For example, the audio manager 170 of FIG. 2, in response to determining that the audio interference metric 136 fails to satisfy the first threshold 156, sends the status request 240 from the first device 104 to the second device 106, the third device 114, the fourth device 214, or a combination thereof, as described with reference to FIG. 2.

The method 500 also includes receiving status information at the first device from the second device, at 504. For example, the audio manager 170 of FIG. 2 receives the status information 250 from the second device 106, the status information 252 from the third device 114, the status information 254 from the fourth device 214, or a combination thereof, as described with reference to FIG. 2.

The method 500 further includes determining whether the status information satisfies a second threshold, at 506. For example, the audio manager 170 of FIG. 2 determines whether the status information 250 satisfies the second threshold 256, the status information 252 satisfies the second threshold 256, the status information 254 satisfies the second threshold 256, or a combination thereof, as described with reference to FIG. 2.

The method 500 includes, in response to determining that the status information satisfies the second threshold, at 506, refraining from sending a first instruction to the second device to cause the second device to reduce an output sound level, at 508. For example, the audio manager 170 of FIG. 2, in response to determining that the status information 254 satisfies the second threshold 256, refrains from sending an instruction to the fourth device 214 to cause the fourth device 214 to reduce an output sound level, as described with reference to FIG. 2.

The method 500 continues to 408. For example, the audio manager 170 of FIG. 2 receives the second audio input 122 that includes the command 138, as described with reference to FIG. 2.

The method 500 includes, in response to determining that the status information fails to satisfy the second threshold, at 506, continuing to 412. For example, the audio manager 170 of FIG. 2, in response to determining that the status information 250 fails to satisfy the second threshold 256, sends the instruction 140 to the second device 106 to cause the second device 106 to reduce an output sound level, as described with reference to FIG. 2.

The method 500 thus enables selectively sending instructions to reduce an output sound level to devices for which status information indicates a setting value, a mode value, or both, corresponding to a higher than threshold output sound level. Settings and operating modes of devices that are likely to have a larger impact on ambient noise are updated.

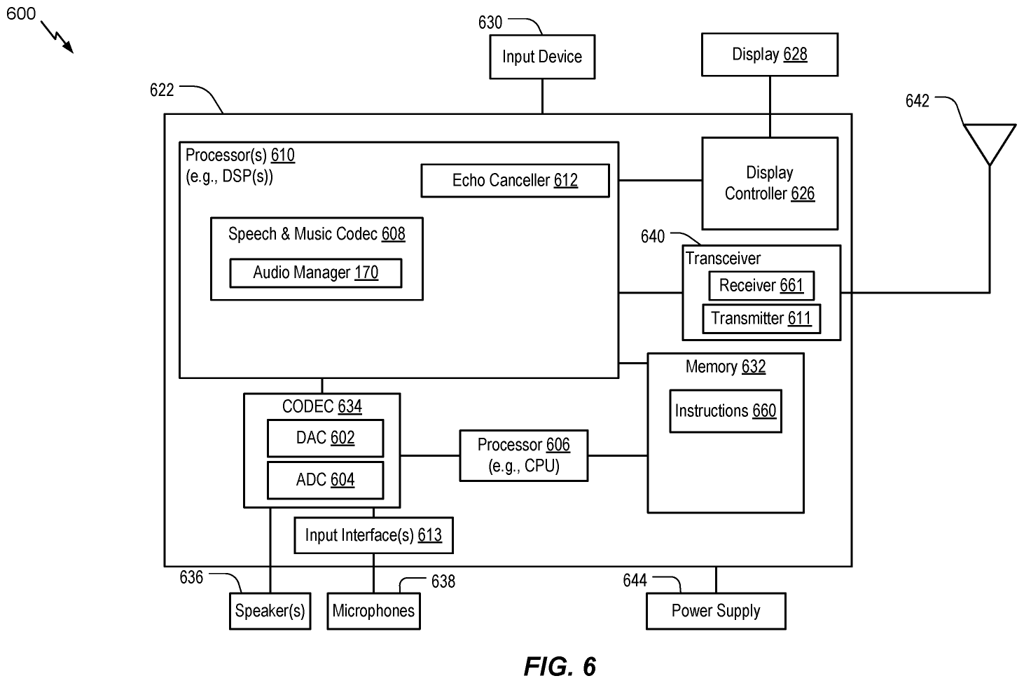

Referring to FIG. 6, a block diagram of a particular illustrative example of a device (e.g., a wireless communication device, a home device, an internet of things (JOT) device, a voice-activated digital assistant, or a combination thereof) is depicted and generally designated 600. In various examples, the device 600 includes fewer or more components than illustrated in FIG. 6. In an illustrative example, the device 600 corresponds to the first device 104, the second device 106, the third device 114 of FIG. 1, the fourth device 214 of FIG. 4, or a combination thereof. In an illustrative example, the device 600 performs one or more operations described with reference to FIGS. 1-5.

In a particular aspect, the device 600 includes a processor 606 (e.g., a central processing unit (CPU)). The device 600 may include one or more additional processors 610 (e.g., one or more digital signal processors (DSPs)). The processors 610 include a speech and music coder-decoder (CODEC) 608, an echo canceller 612, or both. The speech and music CODEC 608 includes the audio manager 170. The processors 610 are coupled via a transceiver 640 to an antenna 642. The transceiver 640 includes a receiver 661, a transmitter 611, or both. In a particular implementation, the receiver 661 includes the receiver 160, the receiver 162 of FIG. 1, the receiver 210, the receiver 262 of FIG. 2, or a combination thereof. In a particular implementation, the transmitter 611 includes the transmitter 110 of FIG. 1, the transmitter 260, the transmitter 264, the transmitter 266 of FIG. 2, or a combination thereof.

Although the speech and music CODEC 608 is illustrated as a component of the processors 610, in other examples one or more components of the speech and music CODEC 608 are included in the processor 606, a CODEC 634, another processing component, or a combination thereof. The device 600 also includes a memory 632. In a particular implementation, the memory 632 includes the memory 132, the memory 182, the memory 186 of FIG. 1, the memory 286 of FIG. 2, or a combination thereof. In a particular aspect, the processors 610, the processor 606, or a combination thereof, includes the processor 184, the processor 188 of FIG. 1, the processor 288 of FIG. 2, or a combination thereof. The device 600 includes a display 628 coupled to a display controller 626. One or more speakers 636, one or more microphones 638, or a combination thereof may be coupled to the CODEC 634. In a particular aspect, the microphones 638 include the microphone 146 of FIG. 1. In a particular aspect, the speakers 636 include the speaker 142 of FIG. 1. The CODEC 634 may include a digital-to-analog converter (DAC) 602 and an analog-to-digital converter (ADC) 604.

In a particular aspect, the CODEC 634 may receive analog signals from the microphones 638, convert the analog signals to digital signals using the analog-to-digital converter 604, and provide the digital signals to the speech and music CODEC 608, such as in a pulse code modulation (PCM) format. The speech and music CODEC 608 may process the digital signals. In a particular aspect, the speech and music CODEC 608 may provide digital signals to the CODEC 634. The CODEC 634 may convert the digital signals to analog signals using the digital-to-analog converter 602 and may provide the analog signals to the speakers 636.

The memory 632 may include instructions 660 executable by the processor 606, the processors 610, the CODEC 634, the audio manager 170, another processing unit of the device 600, or a combination thereof, to perform methods and processes disclosed herein, such as one or more operations described with reference to FIGS. 1-5. In a particular aspect, the instructions 660 include the instructions 108 of FIG. 1. One or more components of the systems and devices described with reference to FIGS. 1-5 may be implemented via dedicated hardware (e.g., circuitry), by a processor executing instructions (e.g., the instructions 660) to perform one or more tasks, or a combination thereof. As an example, the memory 632 or one or more components of the processor 606, the processors 610, the audio manager 170, and/or the CODEC 634 includes a memory device, such as a random access memory (RAM), magnetoresistive random access memory (MRAM), spin-torque transfer MRAM (STT-MRAM), flash memory, read-only memory (ROM), programmable read-only memory (PROM), erasable programmable read-only memory (EPROM), electrically erasable programmable read-only memory (EEPROM), registers, hard disk, a removable disk, or a compact disc read-only memory (CD-ROM). The memory device includes instructions (e.g., the instructions 660) that, when executed by a computer (e.g., a processor in the CODEC 634, the audio manager 170, the processor 606, and/or the processors 610), causes the computer to perform one or more operations described with reference to FIGS. 1-5. As an example, the memory 632 or the one or more components of the processor 606, the processors 610, the audio manager 170, the CODEC 634 is a computer-readable storage device that includes instructions (e.g., the instructions 660) that, when executed by a computer (e.g., a processor in the CODEC 634, the processor 606, and/or the processors 610), cause the computer perform one or more operations described with reference to FIGS. 1-5.

In a particular aspect, the device 600 is included in a system-in-package or system-on-chip device 622, such as a mobile station modem (MSM). In a particular aspect, the processor 606, the processors 610, the display controller 626, the memory 632, the CODEC 634, the audio manager 170, and the transceiver 640 are included in a system-in-package or the system-on-chip device 622. In a particular aspect, an input device 630, such as a touchscreen and/or keypad, and a power supply 644 are coupled to the system-on-chip device 622. Moreover, in a particular aspect, as illustrated in FIG. 6, the display 628, the input device 630, the speakers 636, the microphones 638, the antenna 642, and the power supply 644 are external to the system-on-chip device 622. However, each of the display 628, the input device 630, the speakers 636, the microphones 638, the antenna 642, and the power supply 644 can be coupled to a component of the system-on-chip device 622, such as an interface or a controller. In an illustrative example, the device 600 corresponds to a virtual assistant, a home appliance, a smart device, an internet of things (IoT) device, a communication device, a computer, a display device, a television, a gaming console, a music player, a radio, a video player, an entertainment unit, a personal media player, a digital video player, a camera, a navigation device, a mobile communication device, a smartphone, a cellular phone, a laptop computer, a tablet computer, a personal digital assistant, a display device, an optical disc player, a tuner, a decoder system, an encoder system, or any combination thereof.

In an illustrative aspect, the processors 610 are operable to manage device sound level in accordance with the described techniques. For example, the audio manager 170 receives the first audio input 120 from the microphones 638. The audio manager 170, in response to detecting the keyword 134 in the first audio input 120, determines the audio interference metric 136. The audio manager 170 compares the audio interference metric 136 to the first threshold 156. The audio manager 170 generates the instruction 140 based on the comparison. The transmitter 611 transmits one or more packets corresponding to the instruction 140. The audio manager 170 receives the second audio input 122 from the microphones 638. The audio manager 170 detects the command 138 in the second audio input 122 and performs the actions 158 corresponding to the command 138.

In conjunction with the described aspects, an apparatus is disclosed that includes means for receiving a first audio input. For example, the means for receiving include the microphone 146, the input interfaces 112, the audio manager 170, the first device 104, the system 100 of FIG. 1, the system 200 of FIG. 2, one or more devices configured to receive a first audio input (e.g., one or more processors executing instructions stored at a computer-readable storage device), or any combination thereof.

The apparatus also includes means for determining an audio interference metric based on detecting a keyword in the first audio input. For example, the means for determining include the audio manager 170, the first device 104, the system 100 of FIG. 1, the system 200 of FIG. 2, one or more devices configured to determine the audio interference metric 136 based on detecting the keyword 134 in the first audio input 120 (e.g., one or more processors executing instructions stored at a computer-readable storage device), or any combination thereof. The audio interference metric 136 is based on the first audio input 120.

The apparatus further includes means for initiating transmission of a first instruction to a second device to cause the second device to reduce an output sound level. For example, the means for initiating transmission include the audio manager 170, the transmitter 110, the first device 104, the system 100 of FIG. 1, the system 200 of FIG. 2, one or more devices configured to initiate transmission of the instruction 140 to the second device 106 to cause the second device 106 to reduce an output sound level (e.g., one or more processors executing instructions stored at a computer-readable storage device), or any combination thereof. The transmission of the instruction 140 is initiated based on a comparison of the audio interference metric 136 to the first threshold 156.

As used herein, “coupled” may include communicatively coupled, electrically coupled, magnetically coupled, physically coupled, optically coupled, and combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc.

As used herein, “generating,” “calculating,” “using,” “selecting,” “accessing,” and “determining” may be used interchangeably. For example, “generating,” “calculating,” or “determining” a value, a characteristic, a parameter, or a signal may refer to actively generating, calculating, or determining a value, a characteristic, a parameter, or a signal or may refer to using, selecting, or accessing a value, a characteristic, a parameter, or a signal that is already generated, such as by a component or a device.

Those of skill would further appreciate that the various illustrative logical blocks, configurations, modules, circuits, and algorithm steps described in connection with the aspects disclosed herein may be implemented as electronic hardware, computer software, or combinations of both. Various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the aspects disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary non-transitory (e.g. tangible) storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a memory configured to store a first threshold; and
a processor configured to:
determine an audio interference metric based on detecting a keyword in a first audio input;
perform a comparison of the audio interference metric to the first threshold; and
initiate, based on the comparison, transmission of a first instruction to a second device to cause the second device to reduce an output sound level.

2. The device of claim 1, further comprising:
a microphone coupled to the processor, the microphone configured to receive the first audio input; and
a transmitter coupled to the processor, the transmitter configured to transmit one or more instructions including the first instruction.

3. The device of claim 1, wherein the processor is further configured to:
detect a command in a second audio input, the second audio input received subsequent to the transmission of the first instruction
perform an action based on the command, and
initiate, subsequent to receipt of the second audio input, transmission of a second instruction to the second device to cause the second device to restore the output sound level.

4. The device of claim 1, wherein the processor is further configured to initiate, based on the comparison, transmission of a status request for status information to the second device, and wherein the transmission of the first instruction is initiated based on the status information received from the second device.

5. The device of claim 4, wherein the processor is further configured to perform a second comparison of the status information to a second threshold associated with the second device, wherein the transmission of the first instruction is initiated in response to the second comparison indicating that the status information fails to satisfy the second threshold.

6. The device of claim 5, wherein the second threshold is based on a calibration of the output sound level of the second device.

7. The device of claim 4, wherein the status information indicates a first operating mode of the second device, and wherein the transmission of the first instruction is initiated to cause the second device to change to a second operating mode.

8. The device of claim 1, wherein the first instruction indicates a value of a setting associated with the output sound level of the second device, and wherein the transmission of the first instruction is initiated to cause the second device to update the setting based on the value.

9. The device of claim 1, wherein the processor is further configured to determine a first energy associated with a portion of the first audio input corresponding to the keyword, wherein the audio interference metric is based on the first energy.

10. The device of claim 9, wherein the processor is further configured to determine a second energy associated with the first audio input, wherein the audio interference metric is further based on the second energy.

11. A method of managing device sound level, the method comprising:
receiving, at a first device, a first audio input;
determining an audio interference metric based on detecting a keyword in the first audio input;
performing a comparison of the audio interference metric to a first threshold; and
based on the comparison, sending a first instruction from the first device to a second device to cause the second device to reduce an output sound level.

12. The method of claim 11, further comprising:
subsequent to sending the first instruction, receiving a second audio input that includes a command;
performing an action based on the command; and
subsequent to receiving the second audio input, sending a second instruction from the first device to the second device to cause the second device to restore the output sound level.

13. The method of claim 11, further comprising:
based on the comparison, sending a status request from the first device to a set of devices;
receiving first status information at the first device from the set of devices;
selecting, based on the first status information, a first subset of devices from the set of devices; and
sending instructions to the first subset of devices to cause the first subset of devices to reduce output sound levels,
wherein the first subset of devices includes the second device, and
wherein the instructions include the first instruction.

14. The method of claim 13, further comprising performing a second comparison of second status information corresponding to the second device to a second threshold associated with the second device, wherein the second device is selected in the first subset of devices in response to the second comparison indicating that the second status information fails to satisfy the second threshold.

15. The method of claim 13, wherein the first subset of devices includes a third device, and wherein sending the instructions includes sending a third instruction to the third device to cause the third device to reduce a second output sound level.

16. The method of claim 15, wherein the first instruction indicates a first value of a first setting associated with the output sound level of the second device, wherein the first instruction is sent to the second device to cause the second device to update the first setting based on the first value, wherein the third instruction indicates a second value of a second setting associated with the second output sound level of the third device, and wherein the third instruction is sent to the third device to cause the third device to update the second setting based on the second value.

17. The method of claim 11, further comprising, based on the comparison, sending a second instruction from the first device to a third device to cause the third device to update a setting to a value, wherein the first instruction is sent to the second device to cause the second device to change to a particular operating mode.

18. The method of claim 11, further comprising determining a first energy associated with a portion of the first audio input corresponding to the keyword, wherein the audio interference metric is based on the first energy.

19. The method of claim 18, further comprising determining a second energy associated with the first audio input, wherein the audio interference metric is further based on the second energy.

20. A computer-readable storage device storing instructions that, when executed by one or more processors, cause the one or more processors to:
determine an audio interference metric based on detecting a keyword in a first audio input, the audio interference metric indicating a first level of ambient noise detected in the first audio input; and
based on determining that the first level of ambient noise is greater than a threshold level of ambient noise, initiate transmission of a first instruction from a first device to a second device to cause the second device to reduce an output sound level.

21. The computer-readable storage device of claim 20, wherein the instructions, when executed by the one or more processors, cause the one or more processors to:
detect a command in a second audio input, the second audio input received at the first device subsequent to the transmission of the first instruction
perform an action based on the command; and
subsequent to receipt of the second audio input at the first device, initiate transmission of a second instruction from the first device to the second device to cause the second device to restore the output sound level.

22. The computer-readable storage device of claim 20, wherein the instructions, when executed by the one or more processors, cause the one or more processors to, based on determining that the first level of ambient noise is greater than the threshold level of ambient noise, initiate transmission of a status request for status information from the first device to the second device, and wherein the transmission of the first instruction is initiated based on the status information received from the second device.

23. The computer-readable storage device of claim 22, wherein the instructions, when executed by the one or more processors, cause the one or more processors to perform a comparison of the status information to a second threshold associated with the second device, and wherein the transmission of the first instruction is initiated in response to the comparison indicating that the status information fails to satisfy the second threshold.

24. The computer-readable storage device of claim 23, wherein the second threshold is based on a calibration of the output sound level of the second device as detected at the first device.

25. The computer-readable storage device of claim 22, wherein the status information indicates a first operating mode of the second device, and wherein the transmission of the first instruction is initiated to cause the second device to change to a second operating mode.

26. The computer-readable storage device of claim 20, wherein the first instruction indicates a value of a setting associated with the output sound level of the second device, and wherein the transmission of the first instruction is initiated to cause the second device to update the setting based on the value.

27. The computer-readable storage device of claim 20, wherein the instructions, when executed by the one or more processors, cause the one or more processors to determine a first energy associated with a portion of the first audio input corresponding to the keyword, wherein the audio interference metric is based on the first energy.

28. The computer-readable storage device of claim 27, wherein the instructions, when executed by the one or more processors, cause the one or more processors to determine a second energy associated with the first audio input, wherein the audio interference metric is further based on the second energy.

29. An apparatus comprising:
means for receiving a first audio input;
means for determining an audio interference metric based on detecting a keyword in the first audio input; and
means for initiating transmission of a first instruction to a second device to cause the second device to reduce an output sound level, the transmission of the first instruction initiated based on a comparison of the audio interference metric to a first threshold.

30. The apparatus of claim 29, wherein the means for receiving, the means for determining, and the means for initiating transmission are integrated into at least one of a virtual assistant, a home appliance, a smart device, an internet of things (IoT) device, a communication device, a computer, a display device, a television, a gaming console, a music player, a radio, a video player, an entertainment unit, a personal media player, a digital video player, a camera, or a navigation device.
